(19) United States
(12) Patent Application Publication
(10) Pub. No.: US 2018/0025545 A1
(43) Pub. Date: Jan. 25, 2018

(54) METHOD FOR CREATING VISUALIZED EFFECT FOR DATA

(71) Applicant: Pol-Lin Tai, Taipei City (TW)

(72) Inventor: Pol-Lin Tai, Taipei City (TW)

(21) Appl. No.: 15/651,796

(22) Filed: Jul. 17, 2017

Related U.S. Application Data
(60) Provisional application No. 62/363,859, filed on Jul. 19, 2016.

(51) Int. Cl. G06T 19/00; G06T 13/40; G06T 17/00

(52) U.S. Cl. CPC G06T 19/006; G06T 17/005; G06T 13/40; G06F 3/011

(57) ABSTRACT

A method for creating visualized effect for data within a three-dimensional space is implemented by a processor executing instructions stored in a non-transitory computer-readable medium. The method includes processing data contained in a data space to retrieve at least one item contained therein; determining a data value of an information attribute of the at least one item; creating a virtual element according to the data value of the information attribute; and controlling a display device to project the virtual element onto a specific location in the three-dimensional space.

### CROSS-REFERENCE TO RELATED APPLICATION

This application claims priority of U.S. Provisional Patent Application No. 62/363,859, filed on Jul. 19, 2016.

### FIELD

The disclosure relates to a method and a system for creating visualized effect for data, particularly for creating visualized effect for data contained in a data space within a three-dimensional space.

### BACKGROUND

As communication technologies and the processing powers of electronic processors advance, progressively larger amount of data has become readily available to anyone with an electronic device having network connectivity.

### SUMMARY

Therefore, it may be desirable for a user to gain awareness of the increasing volume of data in an intuitive manner. One object of the disclosure is to provide a method that is capable of creating visualized effect for data contained in a data space within a three-dimensional space.

According to one embodiment of the disclosure, the method may be implemented using a processor that executes instructions, and includes:

processing data contained in a data space to retrieve at least one item contained therein;

determining a data value of an information attribute of the at least one item;

creating a virtual element according to the data value of the information attribute; and

controlling a display device to project the virtual element onto a specific location in the three-dimensional space.

Another effect of the disclosure is to provide a non-transitory computer-readable medium storing instructions that, when executed by a processor, causes a computer to perform the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 illustrates a system communicating with a display device according to one embodiment of the disclosure;

FIG. 2 is schematic diagram for illustrating a scheme for processing data into visualized effect in a virtual space;

FIG. 3 illustrates a number of operations that are implemented by a processor of the system;

FIG. 4 is a flow chart illustrating steps of a method for creating visualized effect for the data according to one embodiment of the disclosure;

FIG. 5 illustrates a tree structure associated with the virtual space;

FIG. 6 illustrates examples for performing a segmentation to divide the virtual space into segments;

FIG. 7 illustrates an example for mapping the data in the data space to the virtual space;

FIG. 8 illustrates a relationship between data elements of the data domain and the virtual elements in the virtual space;

FIG. 9 illustrates an example of mapping an information attribute to an appearance attribute;

FIG. 10 illustrates a fusion process associated with different virtual elements;

FIG. 11 illustrates a relationship between a data group of the data domain and a section node in the virtual space;

FIG. 12 illustrates an exemplary process for assigning the data elements to the specific locations in the virtual space;

FIGS. 13 and 14 are flow charts illustrating exemplary algorithms for a position assigning process;

FIG. 15 illustrates the virtual elements displayed in the virtual space and capable of interacting with a user; and

FIG. 16 illustrates a system integrated in a display device according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

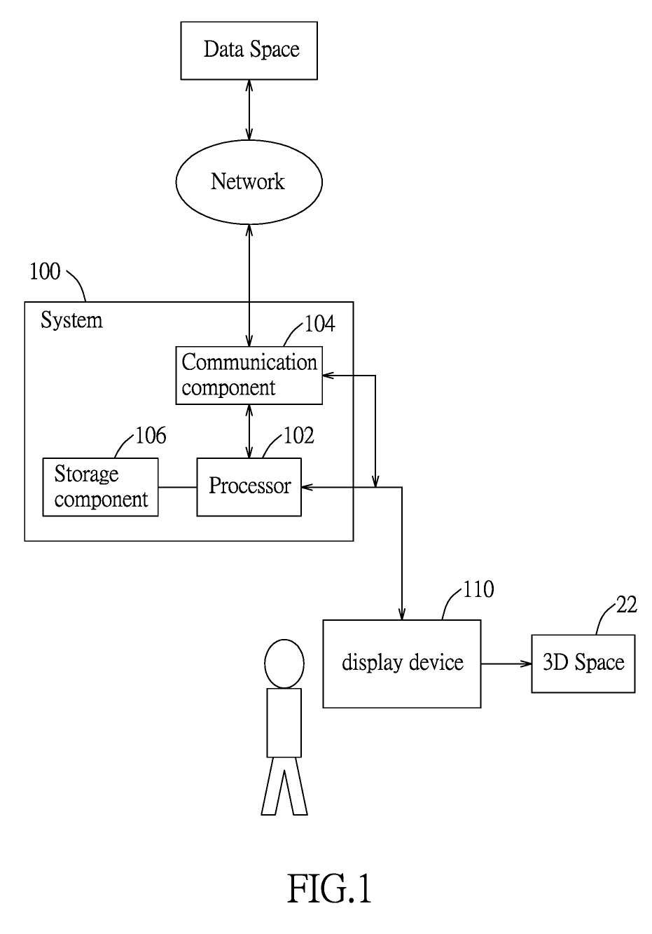

FIG. 1 illustrates a system 100 communicating with a display device 110 according to one embodiment of the disclosure. In this embodiment, the display device 110 may be embodied using a virtual reality device, such as a virtual reality headset that may be worn by a user. In other embodiments, the display device 100 may be embodied using an augmented reality (AR) device, such as a pair of augmented reality glasses that may be worn by a user. The display device 100 may also be embodied using a virtual retinal display device which projects a digital light field into the user's eyes.

In this embodiment, the system 100 includes a processor 102, a communication component 104 and a storage component 106.

The processor 102 is coupled to the communication component 104 and the storage component 106. The processor 102 may be embodied using a processing unit (e.g., a central processing unit (CPU)), and is capable of executing various instructions for performing operations as described below.

The communication component 104 may be embodied using a mobile broadband modem, and is capable of communicating with various electronic devices and/or servers over a network (e.g., the Internet) through wired and/or wireless communication. The storage component 106 is a non-transitory computer-readable medium, and may be embodied using a physical storage device, such as a hard disk, a solid-state disk (SSD), etc.

In some embodiments, the communication component 104 is capable of downloading data from a remote server via the network, and storing the data in the storage component 106.

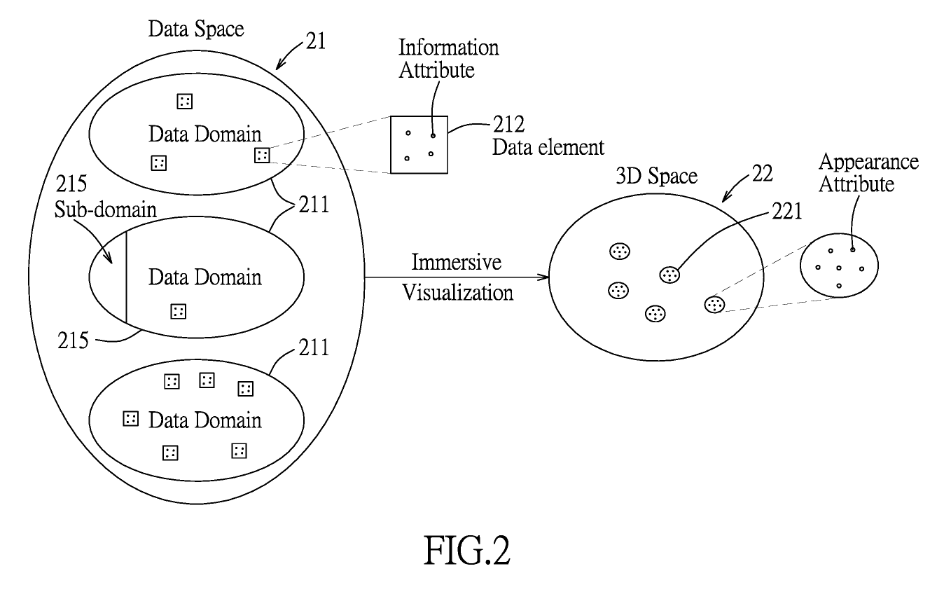

FIG. 2 illustrates a scheme for processing the data so as to allow the display device 110 to project visualize effect representing the processed data onto a three-dimensional (3D) space 22, which is for example a virtual reality (VR) domain 22.

Specifically, the entirety of the data (which may be downloaded from the remote server or retrieved from the storage component 106) may be referred to as a data space 21. In this embodiment, the data space 21 may include statistics of companies that are listed in a public stock exchange (e.g., the New York Stock Exchange (NYSE), the NASDAQ stock market, the Taiwan Stock Exchange (TWSE), etc.). In other embodiments, various other data may be similarly employed.

Data for one specific company (e.g., Taiwan Semiconductor Manufacturing Company Limited) may be referred to as a data element 212 (expressed in FIG. 2 as a square). Each data element 212 may include one or more information attributes (each expressed in FIG. 2 as a dot within the corresponding square) that are each associated with a certain characteristic of the specific company, such as a stock price, revenue, earnings per share (EPS), a trading volume, etc.

Multiple companies may be categorized into different data domains 211 (each expressed in FIG. 2 as an oval that encloses the squares representing the data elements 212 of the corresponding data domain). For example, the companies listed in a specific stock exchange (e.g., the NYSE, the TWSE, NASDAQ, etc.) may be grouped into a data domain 211.

Furthermore, for each of the data domains 211, companies specializing in one specific sector (e.g., technologies, financial, consumer goods) may be grouped into one sub-domain 215 (or data group, expressed by a segmented part of the oval). As a result, a data domain 211 may include one or more sub-domains 215.

As shown in FIG. 2, each data domain 211 or sub-domain 215 may include one or more data elements 212. The data space 21 may include one or more space elements associated with a status of the (entire) data domain 211 (e.g., one or more stock indexes provided by the TWSE, or other stock indexes such as the Standard & Poor's (S&P) 500 index, the Dow Jones Industrial Average (DJIA), etc.). Similarly, each data domain 211 may include one or more domain elements associated with a status of the category 211 (e.g., one or more sector indexes provided by the TWSE).

The three-dimensional space 22 for projection of the data contained in the data space 21 may be prepared in a similar manner. For example, in this embodiment, the three-dimensional space 22 is a ball shaped three-dimensional space. Within the three-dimensional space 22, one or more virtual elements 221 may be generated, each being associated with one of the data elements 212. Each virtual element 221 includes one or more appearance attributes associated with the one or more information attributes of the associated one of the data elements 212 (e.g., a particular company).

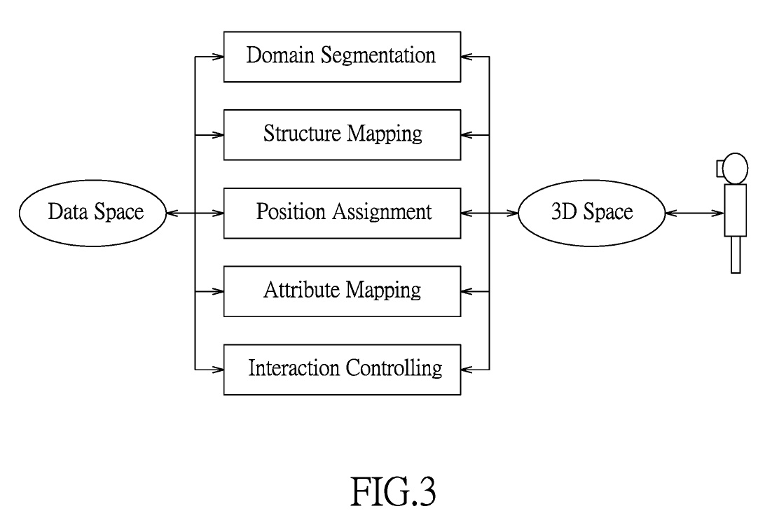

FIG. 3 illustrates a number of operations that is implemented by the processor 102, in order to project the data within the data space 21 (for example, the above mentioned data regarding the companies listed in the TWSE and/or NYSE) onto the three-dimensional space 22 in the form of the virtual elements 221, thereby allowing a user to see the visualized data and interact with the visual elements 221 using a number of user interactions. The relevant details will be described in the succeeding paragraphs.

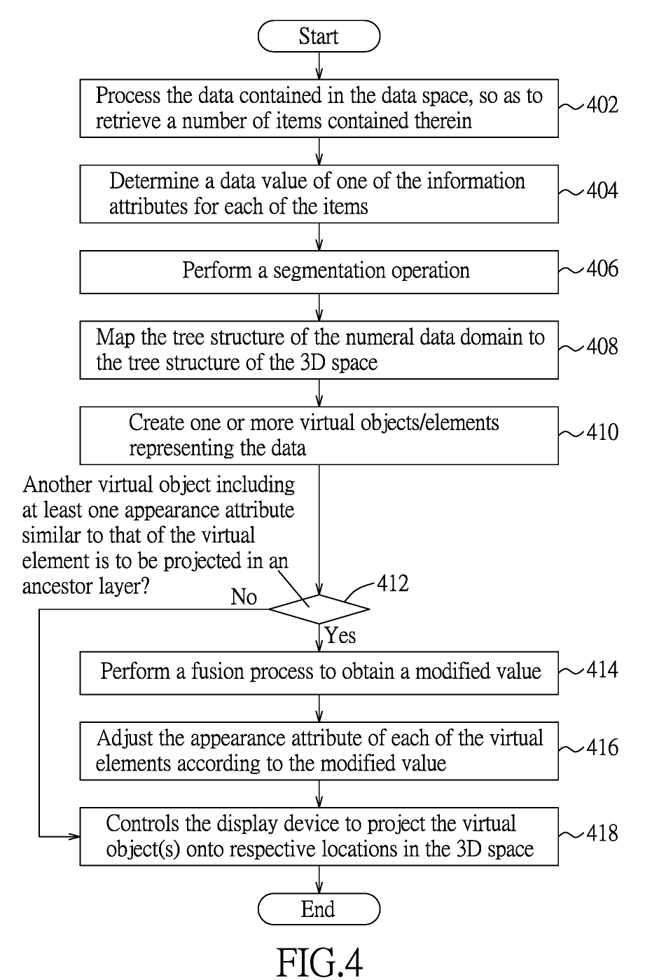

FIG. 4 is a flow chart illustrating steps of a method for creating visualized effect for the data, according to one embodiment of the disclosure. In this embodiment, the method is implemented by the processor 102 executing a number of instructions stored in the storage component 106.

In step 402, the processor 102 processes the data contained in the data space 21, so as to retrieve a number of items contained therein. Throughout the disclosure, the term “item” may refer to a data element, a domain element, or a space element.

Specifically, the processor 102 establishes a tree structure of the data space 21 that includes one or more data layers. Furthermore, the processor 102 determines one of the data layers to which the at least one item belongs.

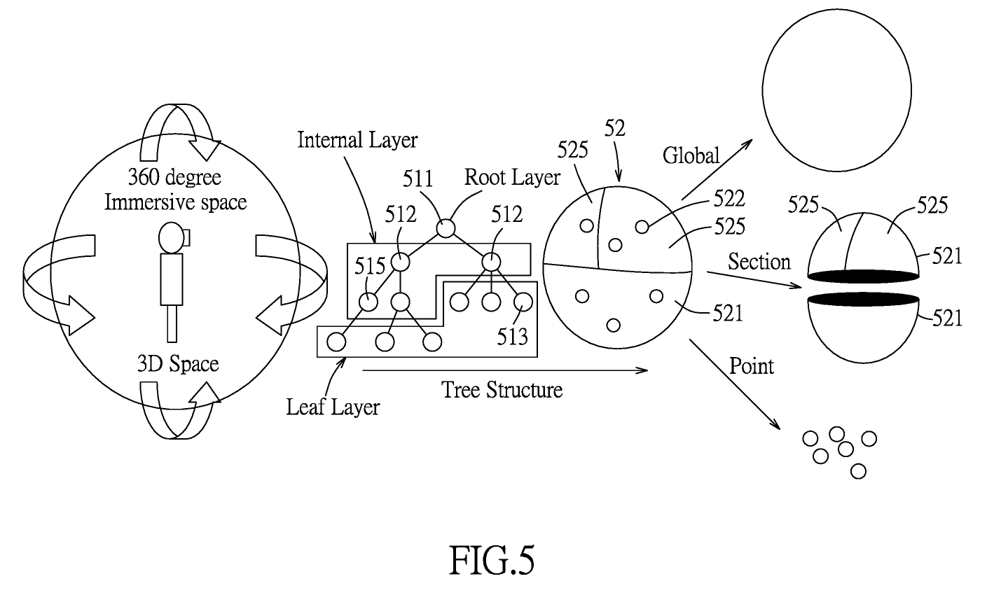

In this embodiment, the tree structure of the data space 21 includes a root layer having a root node corresponding with the entire data space 21, an internal layer having a number of internal nodes each representing a respective one of the categories, and a leaf level having a number of leaf nodes each representing a respective one of the data elements 212 (see FIG. 5).

It is noted however that within the internal layer, the internal nodes may also have parent/child relationships. For example, when it is appropriate to divide a specific one of the data domains 211 into multiple sub-domains 215, a number of additional internal nodes stemming from the internal node representing the specific one of the data domains 211 may be created. As a result, a depth of one of the internal nodes (a number of edges/connections between the root node and the one of the internal nodes) may be larger than 1.

In some embodiments, other structural configurations, including multiple tree structures, may be employed. For example, the structure may only include the root node.

In step 404, the processor 102 determines a data value of one of the information attributes for each of the items. For example, when a relative strength index (RSI) is to serve as said one of the information attributes, a number of previous stock prices or indexes associated with the item may be used in calculating the value of RSI, serving as the data value.

Then, in step 406, the processor 102 arranges the three-dimensional space 22. Specifically, the processor 102 performs a segmentation operation of the three-dimensional space 22 for the data domains 211 of the data space 21, in order to divide the three-dimensional space 22 into a number of non-overlapping segments in accordance with the tree structure of the data space 21.

It is noted that in embodiments of the disclosure, the three-dimensional space 22 is a sphere, and points in the three-dimensional space 22 may be expressed in the form of a set of coordinates of a spherical coordinate system (i.e., (r, θ, φ)).

In one example as shown in FIG. 5, the tree structure 51 of the data space 21 is established to include a root node 511, two internal nodes 512 descending from the root node 511, two internal nodes 515 under one of the internal nodes 512, three leaf nodes 513 under the two internal nodes 515 and three leaf nodes 513 under another one of the internal nodes 512. The three-dimensional space 22 is divided accordingly. Specifically, the three-dimensional space 22 may be divided into two segments 521, for example in the form of two hemispheres as depicted according to the two internal nodes 512. One of the two hemispheres is further segmented into two parts 525, Afterward, the three leaf nodes 513 under each of the internal nodes 512 are placed at positions 522 in a corresponding one of the segments 521 (i.e., the hemispheres). It is noted that in embodiments where a tree structure with a more complicated internal layer is employed (i.e., node(s) with a larger number of depth is present), each of the segments 521 may be further segmented into smaller non-overlapping parts.

In this way, a tree structure of the three-dimensional space 22 is established as well. In this embodiment, the tree structure of the three-dimensional space 22 includes three space layers. Specifically, the tree structure of the three-dimensional space 22 includes a global layer that corresponds with the entire three-dimensional space 22, a section layer having a number of section nodes each corresponding with a respective non-overlapping segment of the three-dimensional space 22, and a point layer having a number of point nodes each corresponding with a respective position 522 within the three-dimensional space 22. In some embodiments, each of the point nodes may correspond with a pixel within the three-dimensional space 22.

It is noted however that other structures may be employed in some embodiments. For example, when the structure of the data space 21 includes only the root node, the three-dimensional space 22 may not need to be segmented and the tree structure thereof may only include the global layer.

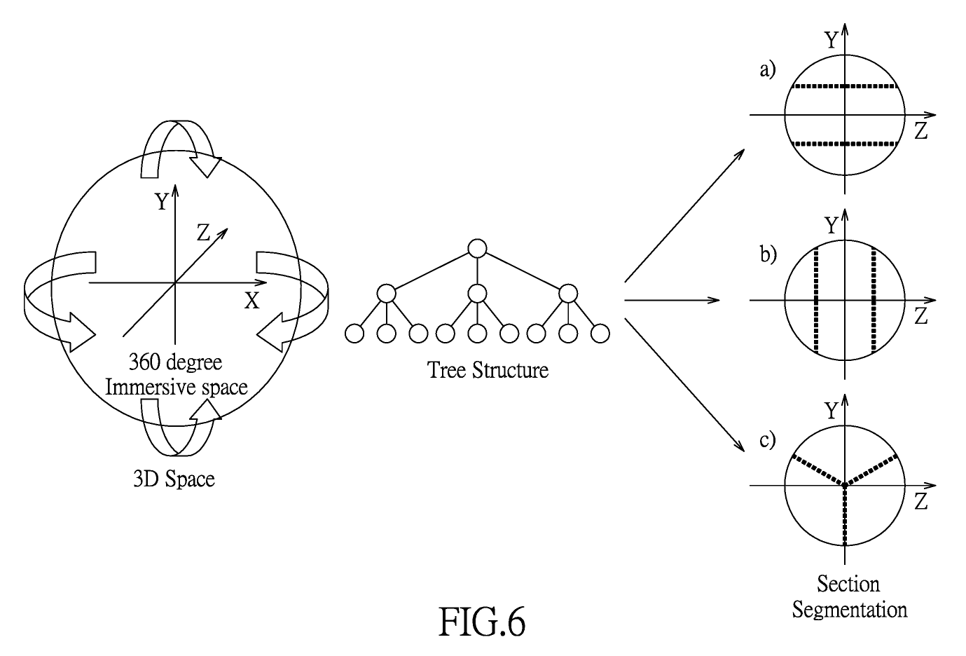

In another example as illustrated in FIG. 6, three internal nodes 512 are present in the tree structure of the data space 21. As a result, the three-dimensional space 22 may be divided into three non-overlapping segments in a specific manner. For example, the three-dimensional space 22 may be divided into three parallel segments with respect to an X-Z plane (see part a) of FIG. 6). Other examples include dividing the three-dimensional space 22 into three parallel segments with respect to an X-Y plane (see part b) of FIG. 6) and dividing the three-dimensional space 22 in a manner as depicted in part c) of FIG. 6.

In step 408, the processor 102 maps the tree structure of the data space 21 to the tree structure of the three-dimensional space 22.

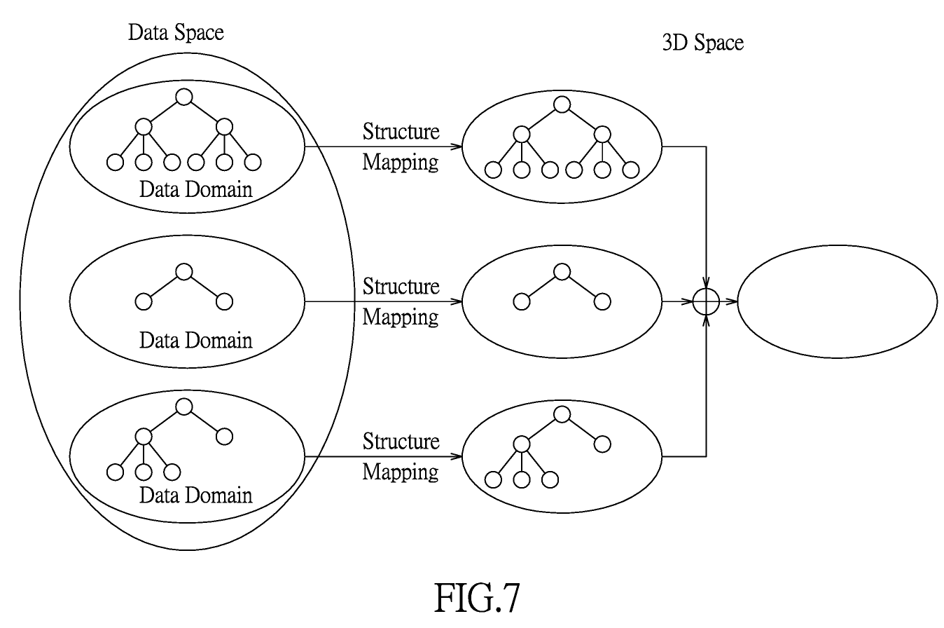

Specifically, in an example as shown in FIG. 7, the data space 21 includes three data domains 211, each being processed to establish a tree structure with various numbers of data layers.

In this configuration, for each of the data domains 211, the root node includes a global identifier (e.g., a universally unique identifier (UUID)) regarding the entire data domain 211. The internal nodes may include information such as specific analytical indicators, identifiers, classifications, etc. The leaf nodes include data elements such as values regarding the financial statistics of companies (e.g., stock price, trade volume, etc.).

Afterward, the tree structure in each of the data domains 211 is mapped onto the tree structure of the three-dimensional space 22. When the tree structure of one the data domains 211 includes three data layers (root, internal, leaf), the mapping may be performed by simply mapping the root layer, the internal layer and the leaf level to the global layer, the section layer and the point layer of the three-dimensional space 22, respectively.

In cases where a tree structure has less than three data layers, the mapping may be done with more flexibility. For example, in the case where the tree structure of the data domain 211 only has one root node, the root node may be mapped to any one of the space layers (global layer, the section layer or the point layer) of the three-dimensional space 22.

It is noted that two rules may be applied in the process of mapping. Firstly, a particular node of the three-dimensional space 22 cannot be mapped to by more than one node in the same data layer; however, a particular node in the data space 21 may be mapped onto more than one node in the three-dimensional space 22. Secondly, a data node stemming from an ancestor node in an ancestor layer in the data space 21 has to be mapped to a level that is not an ancestor layer to the space layer to which the ancestor node is mapped in the three-dimensional space 22. For example, when a root node of a data domain 211 is mapped to the section layer, the internal nodes have to be mapped to the point layer.

In step 410, the processor 102 creates one or more virtual elements 221 representing the data, based on at least the information attribute.

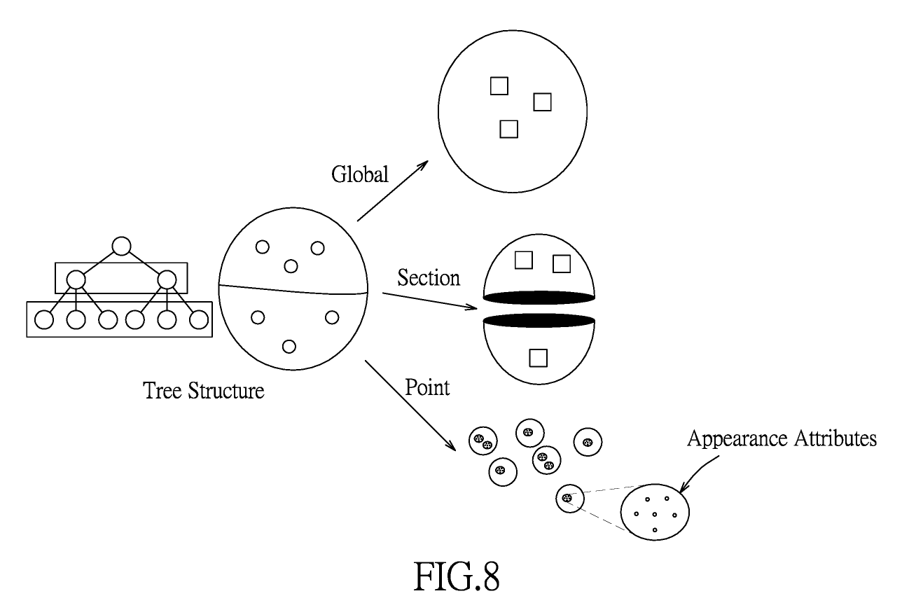

FIG. 8 illustrates a relation of the tree structure of the three-dimensional space 22 after mapping and a number of virtual elements 221 to be created, according to one embodiment of the disclosure. Specifically, in the global layer, the mapping results in three distinct virtual elements 221 being created. In the section layer, three distinct virtual elements 221 are to be created (two on the top hemisphere, one on the bottom hemisphere). In the point layer, six sets of virtual elements 221 are to be created, each set corresponding to one leaf node and including one or more virtual elements 221.

In this embodiment, the virtual element 221 in the global layer may be associated with environment conditions such as a landscape, a climate type, one or more weather phenomena, etc. The climate type, such as tropical climate, tundra climate, desert climate, polar climate, etc., may affect the landscape (e.g., rain forest, frozen landscape, sandy landscape, glacial landscape, etc.) and the overall look (for example, in terms of light, color, land, etc.) of the three-dimensional space 22. The weather phenomenon may be rain, the sun being out, clouds, wind, snow or other seasonal weather phenomena.

Each of the virtual elements 221 in the global layer may include one or more appearance attributes. For example, the rainy weather as a virtual element 221 may include a color of the clouds, a size of the raindrops, rainfall intensity, etc.

Each appearance attribute may be represented using a numeral value, and classified into one or more groups. For example, the size of the raindrops may be classified into groups such as small, medium and large, and the rainfall intensity may be classified into light rain, moderate rain, heavy rain and violent rain.

It is noted that various weather phenomena may be all integrated with a specific climate and displayed in the three-dimensional space 22.

In some cases, appropriate sound effects (e.g., wind blowing, rain falling, etc.) may be incorporated with the virtual elements 221 in the global layer to provide an even more realistic experience to the user.

The virtual element 221 in the section layer may be associated with landform features, such as a hill, a berm, a mound, a ridge, a cliff, a valley, a river, a volcano, a water body, etc.

Each of the virtual elements 221 in the section layer may include one or more appearance attributes. For example, a hill as a virtual element may include a height, a color, a shape of the hill, etc. For example, the height of the hill may be classified into groups such as high, medium and low.

The virtual element 221 in the point layer may for instance be an avatar, an animal, a plant or other virtual objects. Each of the virtual elements 221 in the point layer may include one or more appearance attributes. For example, an avatar as a virtual element in the point layer may include a wide variety of different attributes related to human, such as an age (young, middle aged, old), a gender, a height, a body type, a facial expression (laughing, melancholy, crying), etc.

When more than one of the above mentioned virtual elements 221 is used to indicate the data values of the information attributes of respective items, the virtual elements 221 may be projected onto respective locations of the three-dimensional space 22. In this embodiment, the virtual elements 221 of the global layer may indicate an overall trend/outlook of the stockmarket in Taiwan (using for example a stock index, an over-the-counter (OTC) index), each of the virtual elements 221 of the section layer may indicate a trend of a specific group of stocks, and the virtual elements 221 of the point layer may indicate performances of individual stocks, respectively. For example, a sunny weather may indicate a positive trading day in which the market goes higher, and a crying avatar may indicate that a stock price of a specific company dropped, regardless of the overall market condition.

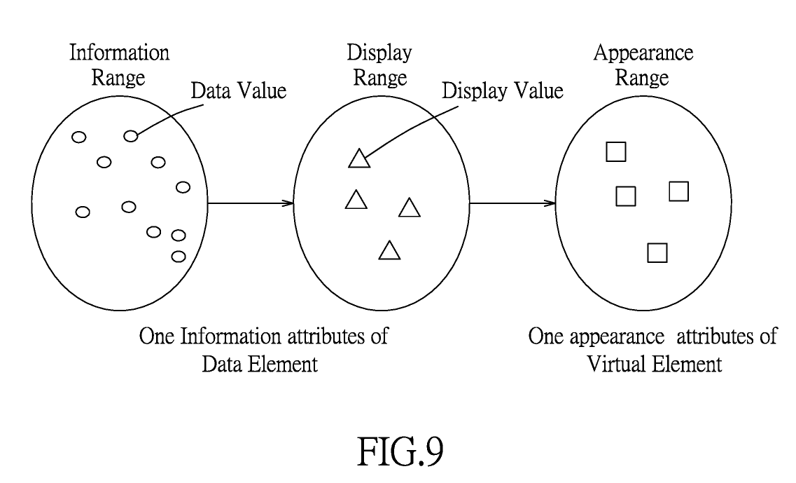

FIG. 9 illustrates steps for processing a specific information attribute in an item (i.e., a data element 212, a domain element or a category element) so as to obtain the appearance attribute of the corresponding virtual element 221.

Specifically, the information attribute may have one of a number of data values (e.g., an integer between 1 and 10, denoted by circles) which constitutes an information range as shown in part a) of FIG. 9. The information range may be divided into a number of mutually exclusive subsets (denoted by triangles) which constitute a display range as shown in part b) of FIG. 9. For example, the integers 1 to 3 may belong to a “low” subset, the integers 4 and 5 may belong to a “medium” subset, the integers 6 to 8 may belong to a “high” subset, and the integers 9 and 10 may belong to an “over” subset. Then, each of the subsets is mapped one-to-one to an appearance attribute (denoted by a square) in an appearance range for the virtual element 221, as shown in part c) of FIG. 9.

In another example, when the information attribute may have any data value within a continuous information range (e.g., RSI may be any number between 0 to 100), the display range may be constituted by a number of non-overlapping subsets each including any data value within a part of the information range. For example, the continuous information range of RSI may be divided into three exclusive subsets [0, 33), [33, 67) and [67, 100). Then, each of the subsets is mapped one-to-one to an appearance attribute.

In one example, the virtual element 221 is the current weather, and the appearance attributes may include weather condition types of “rainy”, “cloudy” and “sunny”.

In another example, the virtual element 221 is an avatar/animal, and the appearance attributes of the appearance range may be actions such as walking, jumping and flying.

In another example, the processor 102 may associate a plurality of appearance values of an appearance attribute respectively with a plurality of appearances that are of the same type (e.g., various hair styles or different amounts of eyebrows of an avatar). Then, the processor 102 may map the data value of the information attribute to one of the appearance values of the appearance attribute. Afterward, the processor 102 may create the virtual element 221 having one of the appearances that is associated with said one of the appearance values to which the data value is mapped.

In step 412, the processor 102 determines, for a virtual element 221 to be projected in one of the space layers, whether another virtual element 221 including at least one appearance attribute similar to that of the virtual element 221 is to be projected in an ancestor layer to the one of the space layers (i.e., the one of the space layers is a descendant layer). For example, for a virtual element 221 in the point layer, the processor 102 determines whether another virtual element 221 with a similar appearance attribute (e.g., a color) is to be projected in the section layer, the root layer or both the section layer and the root layer. When the determination is affirmative, the flow proceeds to step 414. Otherwise, the step proceeds to step 418.

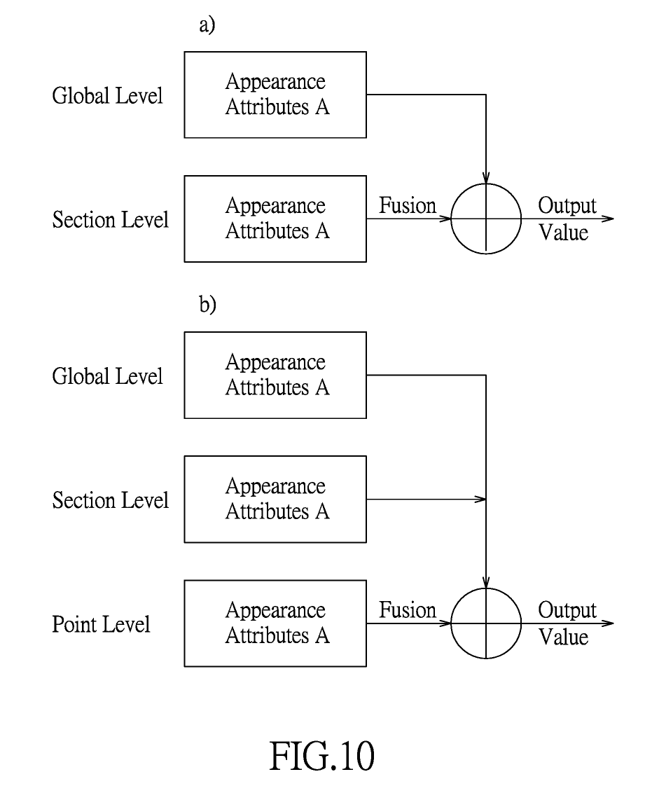

In step 414, when the determination made in step 412 is affirmative, the processor 102 is programmed to perform a fusion process (see FIG. 10), in order to obtain a modified value (Vₘ) according to a first value (V₁) of an appearance attribute of the virtual element 221 in the descendant layer and a second value (V₂) of the same appearance attribute of the another virtual element 221 in the ancestor layer.

In one embodiment (as shown in part a) of FIG. 10), the fusion process includes the processor 102 first weighting the first value (V₁) and the second value (V₂) to obtain a first weighted value (w₁) and a second weighted value (w₂), respectively, and the processor 102 then calculating the modified value (Vₘ) according to the first weighted value (w₁) and the second weighted value (w₂). For example, the modified value (Vₘ) may be calculated by

$${V}_{m} = \frac{( {w}_{1} * {V}_{1} + {w}_{2} * {V}_{2} )}{{w}_{1} + {w}_{2}} .$$

In the case that the virtual element 221 is in the point layer and both the section layer and the global layer include virtual elements 221 with similar appearance attributes (as shown in part b) of FIG. 10), the modified value (Vₘ) may be calculated by

$${V}_{m} = \frac{( {w}_{1} * {V}_{1} + {w}_{2} * {V}_{2} + {w}_{3} * {V}_{3} )}{{w}_{1} + {w}_{2} + {w}_{3}} ,$$

where (w₁) to (w₃) represent the weighted value of the virtual elements 221 in the three space layers, and (V₁) to (V₃) represent the values of an appearance attribute of the virtual elements 221 in the three space layers.

Afterward, in step 416, the processor 102 adjusts the appearance attribute of each of the virtual elements 221 according to the modified value (Vₘ).

In step 418, the processor 102 controls the display device 110 to project the virtual element(s) 221 onto respective location(s) in the three-dimensional space 22.

Specifically, details regarding the manner in which the processor 102 determines the respective locations (also known as a position assigning process) for the virtual elements 221 will be described in the succeeding paragraphs.

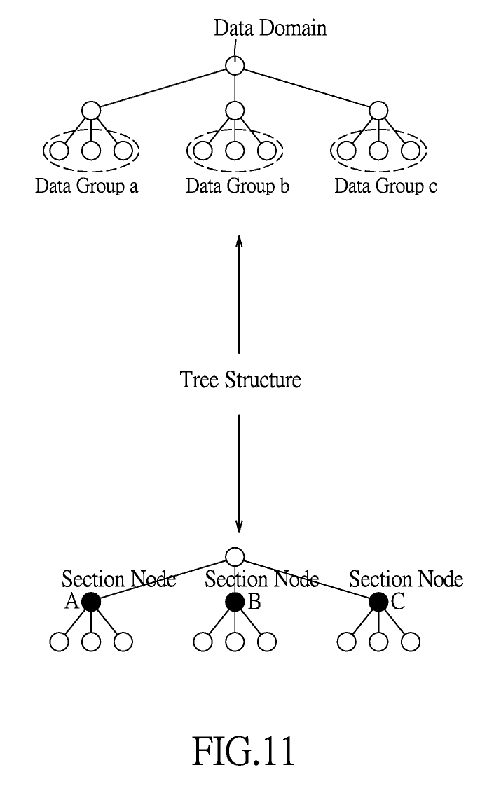

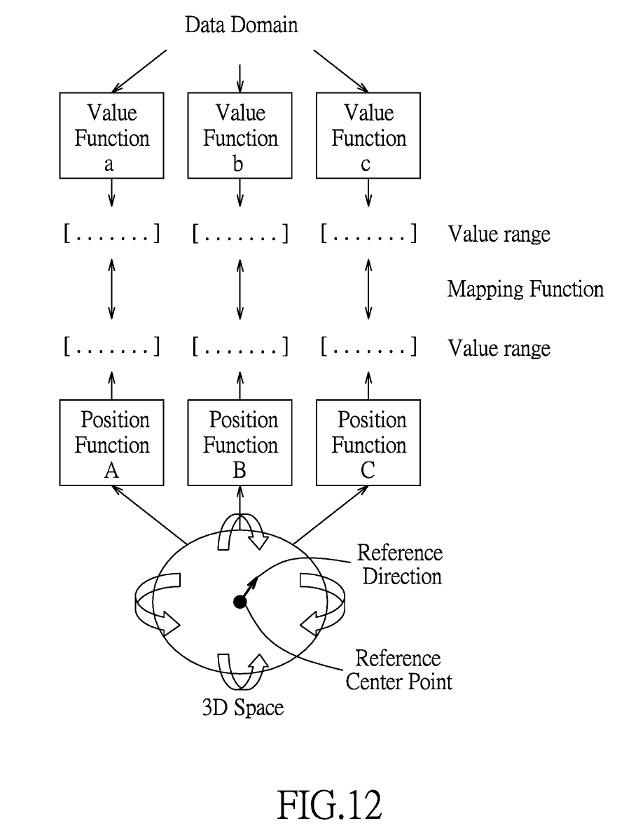

As shown in FIGS. 11 and 12, the processor 102 first applies a specific position function for each section node in the tree structure of the three-dimensional space 22. In this embodiment, three section nodes A, B and C are present, and three position functions are employed such that for each of the three section nodes A, B and C, every point (pixel) is assigned an individual position value.

In the meantime, for each of the data groups a, b and c of a data domain 211, a specific value function is applied such that every data element included therein is assigned a projection value. Afterward, the data groups a, b and c of the data domain 211 are mapped to the section nodes A, B and C of the three-dimensional space 22, respectively, and a mapping function may be employed in order to map each of the data elements within the respective data group to a specific location of a mapped one of the section nodes A, B, C of the three-dimensional space 22, based on the position values and the projection values.

The position functions may be created by setting a reference point and a reference direction within the three-dimensional space 22. In one example, the reference point is designated to an origin of the spherical coordinate system (0, 0, 0), and the reference direction is aligned with the Z-axis of the spherical coordinate system. In another example, the reference point is designated to a point in which the user is imaginarily located in the three-dimensional space 22, and the reference direction is aligned with a line of sight of the user (as indicated by a location and readings of a built-in gyroscope of the display device 110).

With respect to the reference point, the reference direction, and the position functions associated with the respective section nodes, the processor 102 is capable of determining a position value for each pixel of the three-dimensional space 22. In one example, for a specific pixel, the position value is calculated by the following steps. First, the processor 102 determines a distance between the pixel and the reference point. With different distances, the position value assigned to the pixel is different (e.g., the position value may be proportional to the distance). Then, for the pixels having a same distance with the reference point, the processor 102 determines an angle on the X-Z plane formed by a line between the pixel and the reference point and a line that is parallel to the reference direction. With different angles, the position value assigned to the pixel is different (e.g., the position value may be proportional to the angle). Then, for the pixels having a same distance and a same angle, random values that have not been assigned to any other pixels may be assigned by the processor 102 to serve as the position values.

In one example, determining the projection value for each of the data elements 212 may be done by identifying all information attributes included in each of the data elements 212, normalizing the value of each of the information attributes, and combining the normalized values of the information attributes by weighting the normalized values in order to calculate the projection value. It is noted that in this embodiment, the projection value is a rational number within a specific projection value range such as [0, 1]. In another example, the determining the projection value for each of the data elements may be done by selecting one of the information attributes included in each of the data elements, and then normalizing the selected one of the information attributes to the specific projection value range [0, 1].

Then, for each of the data elements 212 in any one of the data domains 211, one position value in the mapped one of the section nodes will be assigned, indicating the position onto which the created virtual element 221 is to be projected. This may be done in a number of ways.

For example, in this embodiment, for each pair of one data domain 211 and a mapped section node (e.g., the data group (a) and the section node (A)), the processor 102 first obtains a (total) number of the data element (s) included in the data domain 211 denoted by (N), a (total) number of all possible value(s) within the projection value range denoted by (M), and a (total) number of pixels included in the mapped section node denoted by (R). Then, the processor 102 compares the number (R) and a product of the numbers (N) and (M).

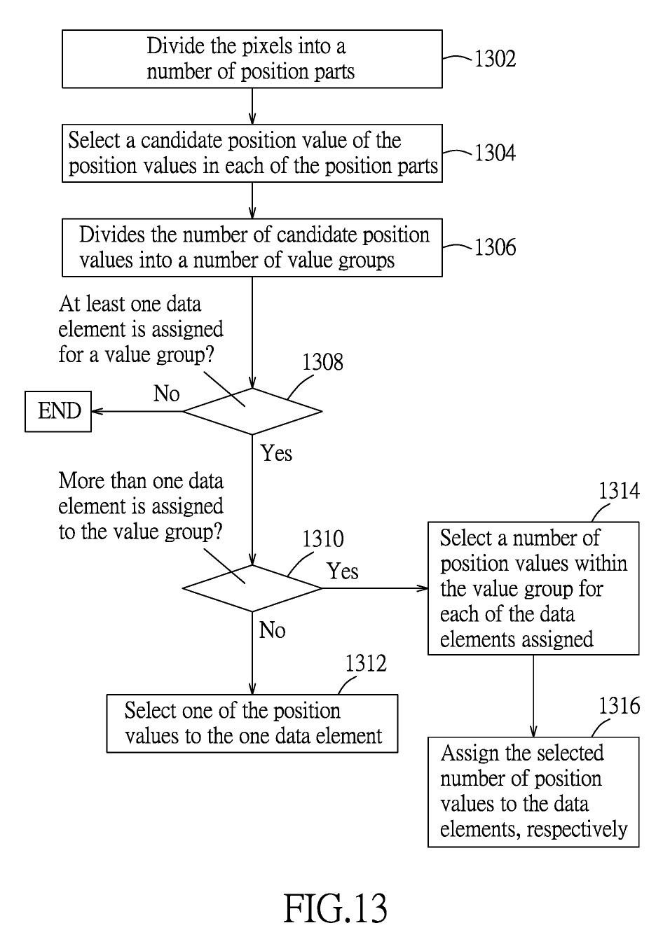

When it is determined that N*M≦R, the processor 102 employs an algorithm as shown in FIG. 13. Specifically, in sub-step 1302, the processor 102 divides the (R) number of pixels into (N*M) number of position parts.

In sub-step 1304, the processor 102 selects a candidate position value of the position values in each of the (N*M) number of position parts, thereby obtaining (N*M) number of candidate position values. In one example, the candidate position value in each of the (N*M) number of position parts is a middle value of the position values.

In sub-step 1306, the processor 102 divides the (N*M) number of candidate position values into (M) number of value groups. Each of the (M) number of value groups contains (N) number of position values and is associated with one of the possible outcomes of the projection value. Then, the processor 102 associates each of the (N) number of data elements 212 with one of the (M) number of the value groups, based on the projection value of the data element 212.

In sub-step 1308, the processor 102 determines, for each of the (M) number of the value groups, whether at least one data element 212 is associated with the value group. When it is determined that no data element 212 is associated with the value group, the process is terminated and no virtual element 221 is projected to parts of the section associated with the value group. Otherwise, the flow proceeds to sub-step 1310.

In sub-step 1310, the processor 102 determines, whether more than one data element 212 is associated with the value group. When it is determined that exactly one data element 212 is associated with the value group, the flow proceeds to sub-step 1312, in which the processor 102 selects one of the (N) number of position values to the one data element 212. Otherwise (for example, the processor 102 determines that a plurality of data elements 212 (e.g., (K) number of data elements 212) are associated with the value group), the flow proceeds to sub-step 1314.

In sub-step 1314, the processor 102 selects a number of position values (e.g., (K) number of position values) within the value group for each of the associated data elements 212.

Then, in sub-step 1316, the processor 102 assigns the selected number of position values to the data elements 212, respectively. In one example, the selected position values are randomly assigned to the data elements 212. In another example, the data elements 212 and/or the position values are sorted before assignment.

It is noted that sub-steps 1308 to 1316 may be repeated for other value groups before all data elements 212 in the data domain 211 are each assigned a position value. With the assigned position values, the virtual elements 221 created based on the data elements 212 may be projected.

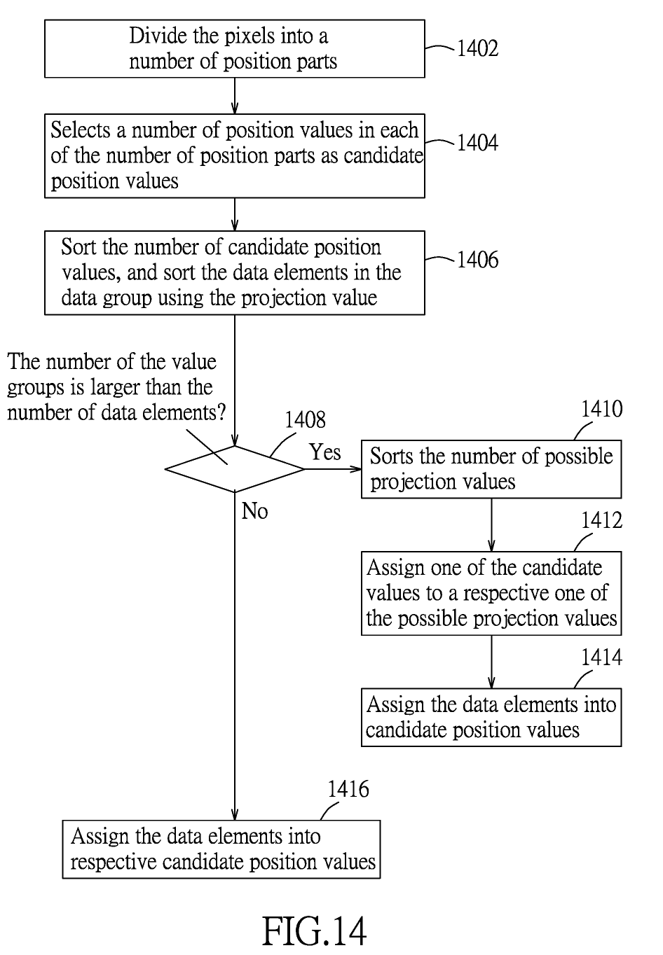

When it is determined that N*M>R, the processor 102 employs an algorithm as shown in FIG. 14.

Specifically, in sub-step 1402, the processor 102 divides the (R) number of pixels into a Max (N, M) number of position parts.

In sub-step 1404, the processor 102 selects Max(N, M) number of position values in each of the Max(N, M) number of position parts as candidate position values, thereby obtaining the Max(N, M) number of candidate position values. In one example, the candidate position value in each of the Max (N, M) number of position parts is a middle value of the of position values.

In sub-step 1406, the processor 102 sorts the Max (N, M) number of candidate position values, and sorts the data elements 212 in the data domain 211 using the projection value. The sorting may be in ascending or descending order. As a result, the sorted candidate position values form a sequence Pᵢ, and the sorted data elements 212 form a sequence nᵢ.

In sub-step 1408, the processor 102 compares the numbers (M) and (N). When it is determined that M>N, the flow proceeds to sub-step 1410. Otherwise, the flow proceeds to sub-step 1416.

In sub-step 1410, it is known that Max(N, M) is (M). The processor 102 then sorts the (M) number of possible projection values. The sorted projection values form a sequence Qᵢ.

In sub-step 1412, the processor 102 assigns one of the (M) number of candidate values to a respective one of the possible projection values, based on the sequences Pᵢ and Qᵢ.

Afterward, in sub-step 1414, the processor 102 attempts to assign candidate position values of the sequence Pᵢ to the data elements 212 of the sequence nᵢ.

Specifically, for a particular data element nⱼ, the processor 102 first determines whether a particular candidate position value Pₖ is not assigned to any one of the data elements 212. When the determination is affirmative, the processor 102 is programmed to compare the numbers (N−j) and (M−k). When it is determined that (N−j)≦(M−k), the processor 102 assigns the candidate position value Pₖ to the data element nⱼ. Otherwise, the processor 102 searches for another candidate position value Pₓ that satisfies the relations x<k and (N−j)≦(M−x), and assigns the candidate position value Pₓ to the data element nⱼ.

When it is determined that the candidate position value Pₖ is already assigned to one of the data elements 212, the processor 102 searches for another candidate position value Pₓ that satisfies the relation x>k, and assigns the candidate position value Pₓ to the data element nⱼ. The processor 102 then attempts to assign a position value to another data element 212 using the similar process.

In sub-step 1416, it is known that Max(N, M) is (N). That is to say, (N) number of candidate position values are obtained for the (N) number of data elements 212. As such, each of the data elements 212 may then be directly assigned a respective one of the candidate position values.

Using the algorithms as shown in FIGS. 13 and 14, the data elements 212 of each of the data domains 211 may be assigned the assigned position values, and the virtual elements 221 created based on the data elements 212 may be projected to a position in the three-dimensional space 22 based on the assigned position values.

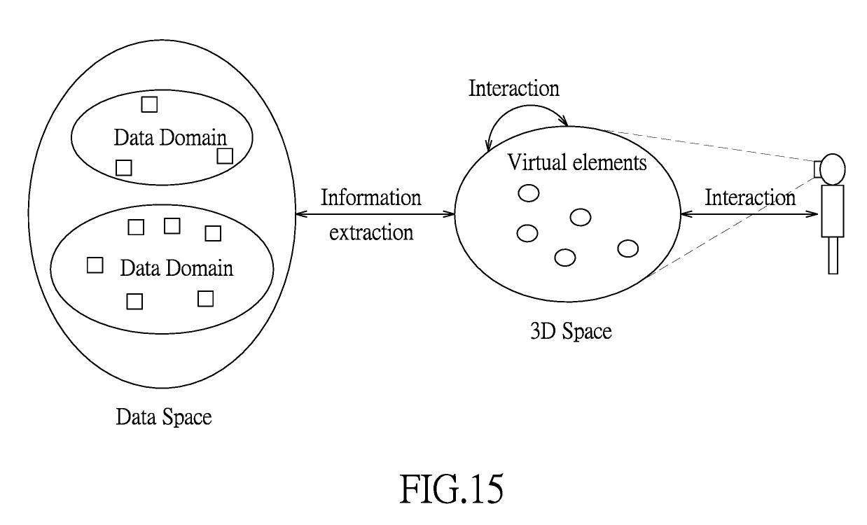

At this stage, the three-dimensional space 22 with the virtual elements 221 is available for the user wearing the display device 110, as shown in FIG. 15.

In this embodiment, the virtual elements 221 may be created with interactive capabilities. That is to say, in response to a user interaction with one of the virtual elements 221, the processor 102 is programmed to generate a reaction that is associated with the visual element 221 and that is perceivable by the user in the three-dimensional space 22, based on the data value of the information attribute of the corresponding item.

In some embodiments, the user interaction includes one or more of the following: a detection that a line of sight of the user is pointed to the virtual element 221; an input signal received from a physical controller (not shown) in signal communication with the processor 102; a voice command captured by a microphone (not shown) in signal communication with the processor 102; and a body gesture of the user captured by a camera and/or a motion sensor (not shown) in signal communication with the processor 102.

For example, one particular virtual element 221 may be an avatar, and one of the appearance attributes thereof may be a facial expression corresponding to a stock performance. When the user interacts with the avatar, the processor 102 may control the avatar to display the reaction by changing the appearance assigned to the avatar (the facial expression) to indicate the stock performance (e.g., smiling for a positive performance).

In some embodiments, the reaction for a virtual element 221 may include popping out the detailed information within the data element 212. For example, a speech balloon may pop out near the avatar to display the detailed information. In some embodiments, the reaction for a virtual element 221 may include a voice notification outputted from the avatar.

Regarding the virtual elements 221 in the global layer and the section layer, the reaction may include a weather change, a change of the landform, and a sound notification associated with the weather.

In one embodiment, in response to a user-input command directed to the virtual element 221, the processor 102 may adjust the space layer in which the virtual element 221 is projected. For example, when a user intends to monitor a stock price of a particular company (which may be originally projected as an avatar or another virtual object) more closely, he/she may “promote” the virtual element to a higher level, such as the section layer (where the stock price is now represented by a height of a mountain).

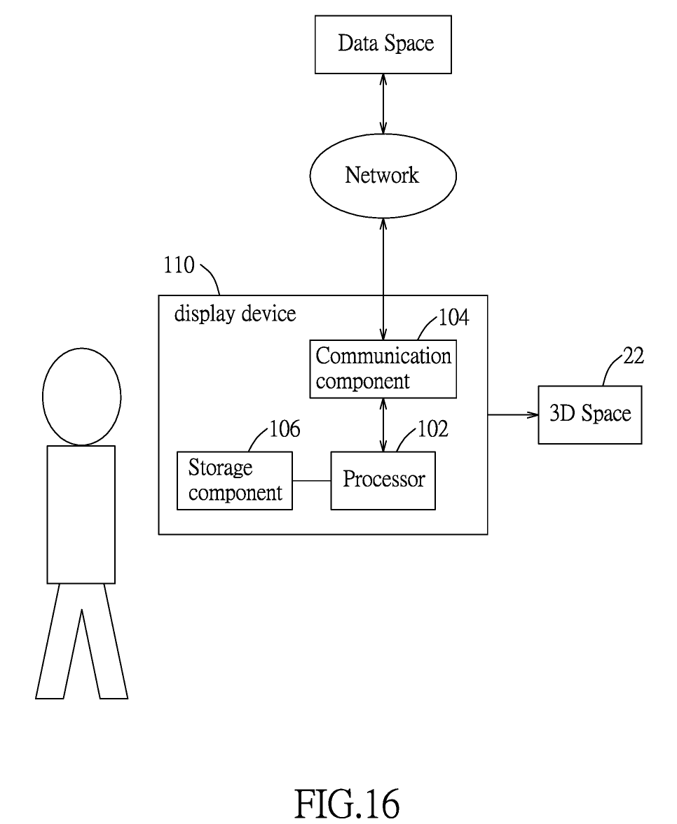

FIG. 16 illustrates a system 100 communicating with a display device 110 (which is similarly a virtual reality device), according to one embodiment of the disclosure. This embodiment differs from the embodiment of FIG. 1 in that the processor 102, the communication component 104 and the storage component 106 are integrated in the display device 110. As a result, the steps of the method as described above are implemented by the processor 102 included in the display device 110.

In one embodiment, the three-dimensional space is the real-world environment, and creating a virtual element and controlling a display device to project the virtual element are implemented using augmented reality (AR) technology.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiment, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for creating visualized effect for data within a three-dimensional space, the method being implemented by a processor executing instructions stored in a non-transitory computer-readable medium, the method comprising:
processing data contained in a data space to retrieve at least one item contained therein;
determining a data value of an information attribute of the at least one item;
creating a virtual element according to the data value of the information attribute; and
controlling a display device to project the virtual element onto a specific location in the three-dimensional space.

2. The method of claim 1, wherein the three-dimensional space is a virtual space created by one of a virtual reality device that communicates with the processor and that is worn by the user and a virtual retinal display device which projects a digital light field into eyes of the user, using virtual reality technology.

3. The method of claim 2, wherein processing the data includes establishing a tree structure of the data domain with a root layer.

4. The method of claim 3, wherein the tree structure of the data space further includes a plurality of data layers descending from the root layer, and processing the data further includes determining one of the data layers to which the at least one item belongs.

5. The method of claim 4, further comprising, before projecting the virtual element:
establishing a tree structure of the virtual space with a number of space layers;
mapping the tree structure of the data space to the tree structure of the virtual space; and
obtaining the specific location in one of the space layers that corresponds to said one of the data layers to which the at least one item belongs.

6. The method of claim 5, wherein the data domain includes a plurality of data elements that are categorized into various categories, and the data layers of the tree structure of the data space include the root layer corresponding with the entire data space, an internal layer having a number of internal nodes each representing a respective one of the categories, and a leaf level having a number of leaf nodes each representing a respective one of the data elements.

7. The method of claim 5, wherein the space layers of the tree structure of the virtual space include a global layer that corresponds with the entire virtual space, a section layer having a number of section nodes each corresponding with a respective non-overlapping segment of the virtual space, and a point layer having a number of point nodes each corresponding with a respective position within the virtual space;
wherein mapping the tree structure of the data space to the tree structure of the virtual space includes mapping the root layer, the internal layer and the leaf level to the global layer, the section layer and the point layer, respectively,
wherein creating a virtual element includes determining a corresponding one of the space layers that corresponds with the data layer of the at least one item, and determining a type of the virtual element according to the corresponding one of the space layers.

8. The method of claim 7, further comprising, in response to a user-input command directed to the virtual element, adjusting the space layer in which the virtual element is projected.

9. The method of claim 5, the virtual element including at least one appearance attribute, the method further comprising:
determining whether the virtual element is to be projected in one of the space layers that is one of a descendant layer and an ancestor layer to another one of the space layers in which another virtual element including at least one appearance attribute similar to that of the virtual element is to be projected;
when the determination is affirmative, performing a fusion process in order to obtain a modified value according to a first value of an appearance attribute of the virtual element and a second value of the same appearance attribute of said another virtual element;
adjusting the appearance attribute of the virtual elements in the descendant layer according to the modified value;
controlling the display device to project the virtual elements onto respective locations in the virtual space.

10. The method of claim 2, further comprising:
setting a reference center point and a reference direction in the virtual space;
determining a position value for each pixel of the virtual space with respect to the reference center point and the reference direction;
calculating a projection value for the data element;
mapping the projection value to a selected position value; and
selecting a location with the selected position value as the specific location.

11. The method of claim 10, further comprising:
obtaining a number (N) of data elements identified in the data space, a number (R) of pixels in the virtual space available for projection, and a number (M) of all possible outcomes of the projection value,
when it is determined that (N*M)≦(R), performing the mapping the projection value to the selected position value by:
dividing the pixels into a number of (N*M) of position parts, and selecting a number (N*M) of position values as candidate position values;
dividing the candidate position values into a number (M) of value groups, each containing a number (N) of position values and being associated with one of the possible outcomes of the projection value;
associating each of the data elements with one of the value groups based on the projection value thereof; and
for each of the value groups, selecting one of the pixels as the specific location.

12. The method of claim 10, obtaining a number (N) of data elements identified in the data space, a number (R) of pixels in the virtual space available for projection, and a number (M) of all possible outcomes of the projection value,
when it is determined that (N*M)>(R), performing the mapping the projection value to the selected position value by:
dividing the pixels into a number Max(N, M) of position parts, and selecting a number Max(N, M) of position values as candidate position values;
when it is determined that (M≧N), for each of the data elements, associating one of the position parts that is not occupied by any other one of the data elements;
when it is determined that (M<N), associating one of the position parts with each of the data elements; and
for each of the position parts, selecting one or more of the pixels as the specific location.

13. The method of claim 1, further comprising:
in response to a user interaction with the virtual element, generating a reaction that is associated with the virtual element and that is perceivable by the user in the three-dimensional space, based on the data value of the information attribute of the at least one item.

14. The method of claim 13, wherein the reaction includes one of a change of appearance assigned to the virtual element and an indication to the user the data value of the information attribute of the at least one item.

15. The method of claim 13, wherein the user interaction includes one or more of the following:
a detection that a line of sight of the user is pointed to the virtual element;
an input signal received from a physical controller communicating with the processor;
a voice command captured by a microphone in signal communication with the processor; and
a body gesture of the user captured by one of a camera and a motion sensor in signal communication with the processor.

16. The method of claim 13, wherein the virtual element includes an avatar, and the reaction includes at least one of a facial expression and a voice notification.

17. The method of claim 13, wherein the three-dimensional space is a virtual space created by a virtual reality device using virtual reality technology and includes a landscape, the virtual element includes a landform, and the reaction includes one of a change of appearance of the landform and a sound notification associated with weather.

18. The method of claim 1, wherein creating a virtual element includes:
associating a plurality of appearance values of an appearance attribute respectively with a plurality of appearances that are the same type of appearance;
mapping the data value of the information attribute to one of the appearance values of the appearance attribute; and
creating the virtual element having one of the appearances that is associated with said one of the appearance values to which the data value is mapped.

19. The method of claim 1, wherein the three-dimensional space is real-world environment, and creating a virtual element and controlling a display device to project the virtual element are implemented using augmented reality technology.

20. A non-transitory computer-readable medium storing instructions that, when executed by a processor, causes a computer to perform operation comprising:
processing data contained in a data space to retrieve at least one item contained therein;
determining a data value of an information attribute of the at least one item;
creating a virtual element according to the data value of the information attribute; and
controlling a display device to project the virtual element onto a specific location in a three-dimensional space.
